(19) United States
(12) Patent Application Publication
(10) Pub. No.: US 2022/0351154 A1
(43) Pub. Date: Nov. 3, 2022

(54) SUB-DAY PLANNING WITHIN A SUPPLY CHAIN PLANNING SYSTEM

(71) Applicant: Kinaxis Inc., Ottawa (CA)

(72) Inventors: Philippe CADIEUX-PELLETIER, Ottawa (CA); Xiangliang MENG, Ottawa (CA)

(21) Appl. No.: 17/732,029

(22) Filed: Apr. 28, 2022

Related U.S. Application Data
(60) Provisional application No. 63/181,274, filed on Apr. 29, 2021.

(51) Int. Cl. G06Q 10/10

(52) U.S. Cl. CPC G06Q 10/1097

(57) ABSTRACT

A supply chain management system often has a data model schema used to configure supply chains. Many fields in this schema track time duration in multiple of days. Systems and methods that make changes to the schema to support sub-day time durations, such as hours, minutes, seconds, and millisecond time duration.

### CROSS-REFERENCE TO RELATED APPLICATIONS

The present application claims the benefit of U.S. Patent Application No. 63/181,274, filed Apr. 29, 2021, and is expressly incorporated by reference in its entirety herein.

### TECHNICAL FIELD

This disclosure relates to the field of supply chain planning. In particular, it relates to the time fields used in supply chain planning.

### BACKGROUND

Supply-chain optimization is the application of processes and tools to ensure the optimal operation of a manufacturing and distribution. This includes the optimal placement of inventory within a supply chain, minimizing operating costs including manufacturing costs, transportation costs, and distribution costs. The process often involves the application of mathematical modelling techniques using computer software.

Management Resource Planning (MRP) implementation often supports a daily planning bucket; that is, the basic unit of time is a day. Certain supply chains can benefit from having a more granular planning bucket; that is, where the unit of time is a minute, or even a second, or even less. Some examples of supply chains that can benefit from a more granular bucket include, but are not limited to, delivering goods with very short shelf life; emergency (last-minute) orders that need to be rushed; lean supply chains requiring just-in-time (JIT) inventory replenishment, etc. When the turn-around time for a demand is very short, tracking the time taken by each step of supply chain with fine granularity can make the difference between planning a demand to be on time versus a demand that is late. The methods and systems disclosed herein, aim to add support for such fine-planning granularity when using MRP by changing the units and associated algorithms used in planning for, but not limited to, lead times and transit times.

### BRIEF SUMMARY

A supply chain management system often has a data model schema used to configure supply chains. Many fields in this schema track time duration in multiple of days. The present disclosure describes changes to the schema to support sub-day time durations, including basic time units such as minutes, seconds, tenths-of-seconds, hundredths-of-seconds, milliseconds, and so on.

Such supply chain management systems often use algorithms to perform date arithmetic using supply chain instance-specific calendars. The methods and systems disclosed herein update those algorithms to support time durations using basic time units such as minutes, seconds, tenths-of-seconds, hundredths-of-seconds, milliseconds, and so on.

In some embodiments, a calendar can be traversed, adding or subtracting time durations within each calendar range until the desired addition or subtraction is complete. Further implementation may include pre-calculating a skip list within calendars to accumulate large portions of time with each step of the calendar traversal.

The changes described above allow for supply chains implemented within the supply chain management system to be configured to execute sub-day planning, supporting time durations using basic time units such as minutes, seconds, tenths-of-seconds, hundredths-of-seconds, milliseconds, and so on.

In one aspect, a computer-implemented method includes storing, by a processor, a contiguous sequence of non-overlapping entry ranges of a calendar, each entry range includes a starting time point and an end time point, each starting time point and each end time point represented as a 32-bit data structure or a 64-bit data structure. The computer-implemented method also includes receiving, by the processor, a work order, the work order having a starting time and a duration. The computer-implemented method also includes converting, by the processor, the duration into sub-day units. The computer-implemented method also includes selecting, by the processor, a first calendar entry with an entry end time point that is after the starting time of the work order. The computer-implemented method also includes calculating, by the processor, a first difference between the entry end time point and the starting time of the work order; comparing, by the processor, the duration and the first difference. The computer-implemented method also includes adding, by the processor, the duration to the starting time of the work order; if the duration is less than the first difference. The computer-implemented method also includes if the duration is greater than the first difference a) obtaining, by the processor, a current time remaining for the work order, equal to the duration minus the difference. The computer-implemented method also includes if the duration is greater than the first difference b) moving, by the processor, to a subsequent calendar entry. The computer-implemented method also includes if the duration is greater than the first difference c) comparing, by the processor, the current time remaining to an entry duration. The computer-implemented method also includes if the duration is greater than the first difference d) adding, by the processor, the current time remaining to an entry starting time of the subsequent calendar entry if the current time remaining is less than the entry duration. The computer-implemented method also includes if the duration is greater than the first difference if the current time remaining is greater than the entry duration subtracting, by the processor, the entry duration from the current time remaining, and returning, by the processor, to step b).

In one aspect, a system includes a processor. The system also includes a memory storing instructions that, when executed by the processor, configure the system to store a contiguous sequence of non-overlapping entry ranges of a calendar, each entry range includes a starting time point and an end time point, each starting time point and each end time point represented as a 32-bit data structure or a 64-bit data structure. The system also includes a memory storing instructions that, when executed by the processor, configure the system to receive a work order, the work order having a starting time and a duration. The system also includes a memory storing instructions that, when executed by the processor, configure the system to convert the duration into sub-day units. The system also includes a memory storing instructions that, when executed by the processor, configure the system to select a first calendar entry with an entry end time point that is after the starting time of the work order. The system also includes a memory storing instructions that, when executed by the processor, configure the system to calculate a first difference between the entry end time point and the starting time of the work order, compare the duration and the first difference. The system also includes a memory storing instructions that, when executed by the processor, configure the system to add the duration to the starting time of the work order if the duration is less than the first difference. The system also includes a memory storing instructions that, when executed by the processor, configure the system to if the duration is greater than the first difference a) obtain a current time remain for the work order equal to the duration minus the difference. The system also includes a memory storing instructions that, when executed by the processor, configure the system to if the duration is greater than the first difference b) move to a subsequent calendar entry. The system also includes a memory storing instructions that, when executed by the processor, configure the system to if the duration is greater than the first difference c) compare the current time remaining to an entry duration. The system also includes a memory storing instructions that, when executed by the processor, configure the system to if the duration is greater than the first difference d) add the current time remaining to an entry starting time of the subsequent calendar entry if the current time remaining is less than the entry duration. The system also includes a memory storing instructions that, when executed by the processor, configure the system to if the duration is greater than the first difference if the current time remaining is greater than the entry duration subtract the entry duration from the current time remaining, and return to step b).

In one aspect, a non-transitory computer-readable storage medium, the computer-readable storage medium including instructions that when executed by a computer, cause the computer to store a contiguous sequence of non-overlapping entry ranges of a calendar, each entry range includes a starting time point and an end time point, each starting time point and each end time point represented as a 32-bit data structure or a 64-bit data structure. The non-transitory computer-readable storage medium also includes receive a work order, the work order having a starting time and a duration. The non-transitory computer-readable storage medium also includes convert the duration into sub-day units. The non-transitory computer-readable storage medium also includes select a first calendar entry with an entry end time point that is after the starting time of the work order. The non-transitory computer-readable storage medium also includes calculate a first difference between the entry end time point and the starting time of the work order, compare the duration and the first difference. The non-transitory computer-readable storage medium also includes add the duration to the starting time of the work order if the duration is less than the first difference. The non-transitory computer-readable storage medium also includes if the duration is greater than the first difference a) obtain a current time remain for the work order equal to the duration minus the difference. The non-transitory computer-readable storage medium also includes if the duration is greater than the first difference b) move to a subsequent calendar entry. The non-transitory computer-readable storage medium also includes if the duration is greater than the first difference c) compare the current time remaining to an entry duration. The non-transitory computer-readable storage medium also includes if the duration is greater than the first difference d) add the current time remaining to an entry starting time of the subsequent calendar entry if the current time remaining is less than the entry duration. The non-transitory computer-readable storage medium also includes if the duration is greater than the first difference if the current time remaining is greater than the entry duration subtract the entry duration from the current time remaining, and return to step b).

In some embodiments of the method, the system and the non-transitory computer-readable storage medium, each starting time point and each end time point can be represented as a 32-bit data structure; and the sub-unit can be either minutes or seconds. In some embodiments, each starting time point and each end time point can be represented as a 64-bit data structure; and the sub-unit can be milliseconds. In some embodiments, the calendar can be a customized calendar. In some embodiments, the calendar can be an everyday calendar, a workday calendar, a seasonal calendar, a weekly calendar, a monthly calendar, or a work shift calendar. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, and the drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Like reference numbers and designations in the various drawings indicate like elements.

FIG. 1 illustrates an example of a system for sub-day planning in accordance with one embodiment.

FIG. 2 shows an example of lead times in an embodiment of a supply chain planning algorithm.

FIG. 3 illustrates a Table, in which calendars are defined as a set of entries, in accordance with one embodiment.

FIG. 4 illustrates a Table, in which calendars are defined as a set of entries, in accordance with one embodiment.

FIG. 5 illustrates a Table, in which calendars are defined as a set of entries, in accordance with one embodiment.

FIG. 6 illustrates performance of operations in an embodiment, using the table shown in FIG. 4.

FIG. 7 illustrates a block diagram in accordance with one embodiment.

### DETAILED DESCRIPTION

A key part of supply chain planning is the processing of lead times. Lead times can be configured in multiple ways to model real life lead times in the business of customers. Using these lead times, various dates can be calculated that are used to determine availability and/or pre-building of demands to satisfy them on time.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

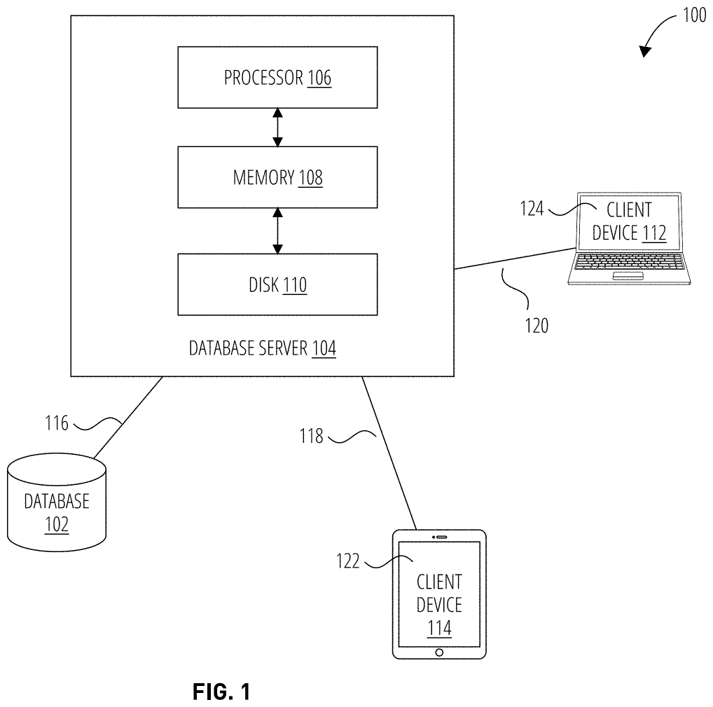

FIG. 1 illustrates a non-limiting example of a systems 100 for sub-day planning in accordance with certain embodiments of the present disclosure. System 100 includes a database server 104, a database 102, and client devices 114 and 112. Database server 104can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

FIG. 1 illustrates an example 200 of lead time determination in an embodiment of a supply chain planning.

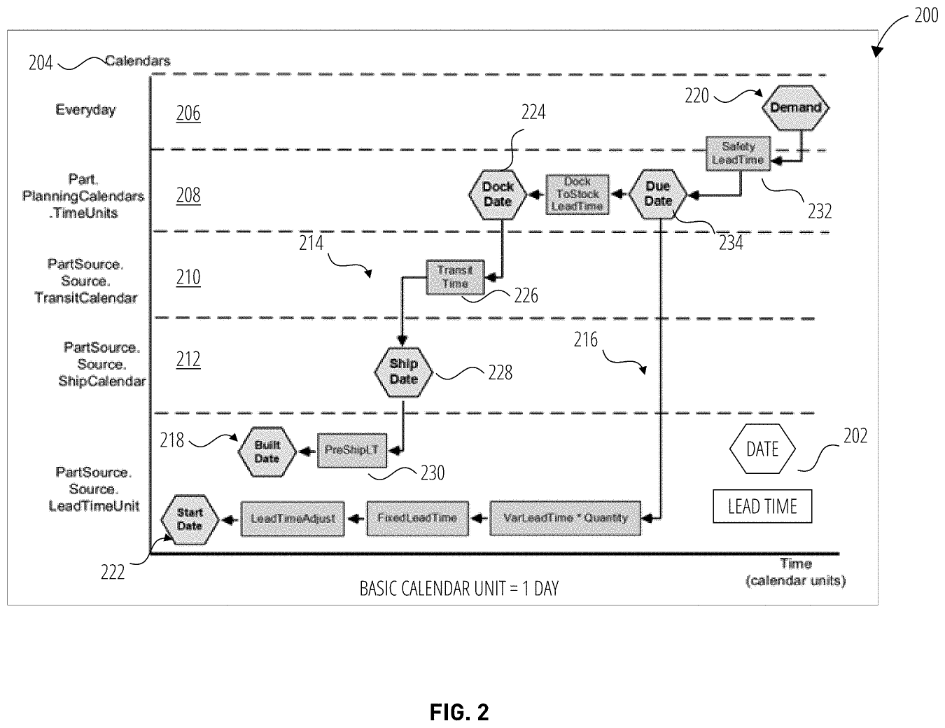

In FIG. 2, the determination of a lead time is based on a Demand date 220. Such a determination is illustrated by the series of arrows that proceed from right to left (either through first method 214 or second method 216). The Demand date 220 is when an item needs to be ready. In order to calculate how much time is needed to have the item ready by demand date 220, one must go back in time to calculate when the item needs to be built, shipped, and so on, such that the item is ready by demand date 220. Therefore, in FIG. 2, a plan to produce an item by demand date 220 is shown by arrows going from right to left, whereas execution of that plan is from left to right.

In FIG. 2, there a series of calendars 204, with each swim lane corresponding to a type of calendar. In FIG. 2, there are four types of calendars (as shown by four swim lanes): swim lane 206 corresponding to an everyday calendar; swim lane 208 corresponding to part planning calendars; swim lane 210 corresponding to a transit calendar; and swim lane 212 corresponding to a shipping calendar.

Each type of calendar has its own schedule. For example, the ‘Everyday’ calendar in swim lane 206 refers to a regular calendar, with seven days in a week, and either 30 or 31 days in a month (except for February). In another example, the ‘Transit’ calendar in swim lane 210 can correspond to a workday calendar which only includes five workdays every week (and omits weekends). In yet another example, the ‘Shipping’ calendar in swim lane 212 can correspond to the schedule of shift workers who work only on Mondays, such that the only calendar entries in the Shipping calendar are every Monday. Similarly, the various calendars in the swim lane 208 for ‘Planning’ calendars, may have its own schedule, according to the number of days set aside for planning in a given month. While FIG. 2 illustrates four types of calendars 204, embodiments can include more or fewer swim lanes, and thus more or fewer types of calendars 204.

In FIG. 2, the safety lead time 232 is used to calculate a due date using the planning calendar (swim lane 208), although it is shown as straddling between the demand date 220 (which uses an Everyday calendar) and the due date 234 (which uses a calendar that is different from the Everyday calendar).

In FIG. 2, planning granularity in the core algorithms is daily: all lead times and calculations are rounded on date boundaries. In FIG. 2, there are two ways to calculate lead times: first method 214, and second method 216. First method 214 calculates the overall lead time between build date 218 and demand date 220. Second method 216 calculates the overall lead time between start date 222 and demand date 220.

A key 202 is shown for each method, in which a lead time is shown as a rectangle, and a date is shown as a hexagon. The rectangle represents a value, such that the value is added to the date from which the box proceeds (that is, to the right of the rectangle), in order to arrive at the next date (that is, to the left of the rectangle). For example, transit time 226 represents a value that is added to the dock date 224, in order to get the ship date 228. When adding the value in the rectangle to a date, the results will depend on the calendar used by the rectangle. For example, if a starting-point date is on a Friday, followed by a +1 value in the rectangle, the result would depend on the type of calendar used by the rectangle. For example, if an Everyday calendar is used, the resulting date would be Saturday, the next day in the Everyday calendar. However, if a WorkDay calendar is used, then the resulting date would be Monday, since the WorkDay calendar has no entries during the weekend.

While two methods are shown, there can be fewer or more methods. The two different methods 214 and 216 each illustrate a unique way of modeling processes. For example, first method 214 illustrates a process in which more shipping is involved than second method 216. In first method 214, inventory is shipped to a dock (see dock date 224), and then spends time in transit (226), until the ship date (228). A ‘Preship’ lead time (230) is included in first method 214, as a buffer to allow for extra time. On the other hand, second method 216 does not include any shipping process, this method bypasses swim lane 210 and swim lane 212. For example, second method 216 may be for a process in which inventory is moved from one part of a building structure to another part of the same building structure.

Basic Date Arithmetic

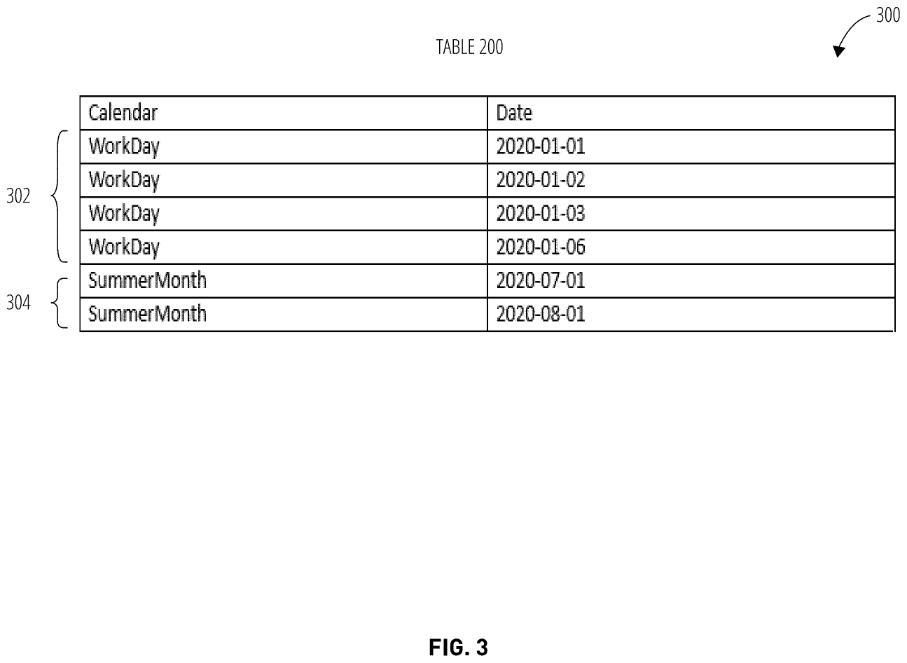

FIG. 3 illustrates a Table 300, in which calendars are defined as a set of entries, in accordance with one embodiment. In FIG. 3, two defined calendars are shown: a workday calendar 302 (with four entries) and summer month calendar 304 (with two entries).

For workday calendar 302, the four entries correspond to four workdays, and omit the two dates 2020-01-04 and 2020-01-05, which are non-workdays (for example, Saturday and Sunday, respectively). For summer month calendar 304, each entry corresponds to the first day of a month; the two entries correspond to July 1 and August 1.

The values for each unique calendar are accumulated and sorted into a contiguous sequence, which can contain at most 2¹⁶ (or 65,536) entries, since dates are conventionally modelled using 16-bit integers. For example, in Table 300, the stored contiguous sequence can be: {2020-01-01}, {2020-01-02}, {2020-01-03}, {2020-01-04}, and so on. Performing additions and subtractions using a calendar (for example, in order to calculate a lead time) involves obtaining that value that is a given distance away from a current day.

For example, calculating two days from the January 2, 2021 using the workday calendar 302, can be performed as follows. of calculating “2020-01-02+2”, using the workday calendar as following (notice how there are no entries for 2020-01-04 and 2020-01-05 since those are weekend days):

Current Date----------------------------------------------+2

| | | | |
|---|---|---|---|
| 2020-01-01 | 2020-01-02 | 2020-01-03 | 2020-01-06 |

The answer to “2020-01-02+2” is therefore “2020-01-06”, when using workday calendar 302. As can be seen above, the calculation is relatively simple: an end date can be calculated from a start date, with a lead time of ‘N’ days, by simply moving over ‘N’ entries in the contiguous list of date entries.

In FIG. 2 and FIG. 3, the minimum basic unit is one day. However, with the presence of the internet of things (IOT), where everything can be tracked down to, for example, the millisecond, and where a number of companies provide guarantees for next-day deliveries, daily granularity may not be precise enough to meet a company's goals. The systems and methods disclosed herein aim to address this shortcoming by changing planning granularity to units less than one day; for example, basic time units such as minutes, seconds, tenths-of-seconds, hundredths-of-seconds, milliseconds, and so on. In order to do so, however, the dates (which now include units of days and sub-day units) are stored in a different way than dates involving just days as the basic time unit.

DateTime Support

In an embodiment, a supply chain planning algorithm models dates as a 16-bit integer, counting days since Jan 1, 1970. That is, every single day, since January 1, 1970 is stored as a 16-bit integer. While the arbitrary date of January 1st, 1970 at 00:00:00 UTC is used as the beginning of an epoch, from which all points in time are offset, there can be other embodiments in which a different starting point of an epoch is used from which to offset future points in time.

In order to support sub-day planning, the algorithm can be amended to include DateTime, which is a 32-bit integer that counts the number of seconds since Jan 1, 1970. That is, the number of seconds since January 1, 1970 is roughly 1.6 billion (as of April 2022). This can fit in 32 bits since 32 bits can fit up to 2³² (or roughly 4.3 billion) entries. However, there are roughly 1.6 trillion milliseconds since January 1, 1970 (as of April 2022), which means that the use of milliseconds cannot be represented using 32 bits, but would instead require 64 bits. That is, the number of bits required is dependent on the granularity of the sub-day unit, since enough bits are needed in order to quantify each unit since January 1, 1970.

Lead Time Conversion

In order to support sub-day planning, lead times can also have a granularity that includes one or more units that are less than a day unit. For example, lead times can be defined using, minutes, seconds, and so on. is by the second.

In an embodiment, the reduction of the basic time unit (from day to sub-day units) can be achieved using performance calculations, such that a current floating point field can be converted to a time duration. That is, a conversion function can be defined that converts from floating point to a time duration. This implies that a basic unit is configured to specify how many sub-units are equivalent to a 1.0 lead time value. As an example, the sub-units can be minutes, seconds, milliseconds, and so on. In an embodiment of the systems and methods disclosed herein, a 1.0 lead time value is configured as 8 hours (that is, 1.0 lead time=8 hours). In this manner, a fractional lead times can then be calculated. For example, a lead time of 1.5 would correspond to 12 hours. If the sub-unit is minutes, then 1.5 (lead time) equals 720 minutes. If the sub-unit is seconds, then a lead time of 1.5 is equal to 43,300 seconds.

DateTime Arithmetic

The supply chain planning algorithm described above, supports the concept of a Calendar that is applied to most calculations. For example, application of safety lead times results in the uses of a safety lead-time calendar, which may apply to every day; applying transit lead-time may use the transit lead-time calendar which may be in weeks; while pre-ship lead times may use a work-day calendar which may only use workdays. Each calendar is completely configurable by a customer.

Sub Day DateTime Arithmetic

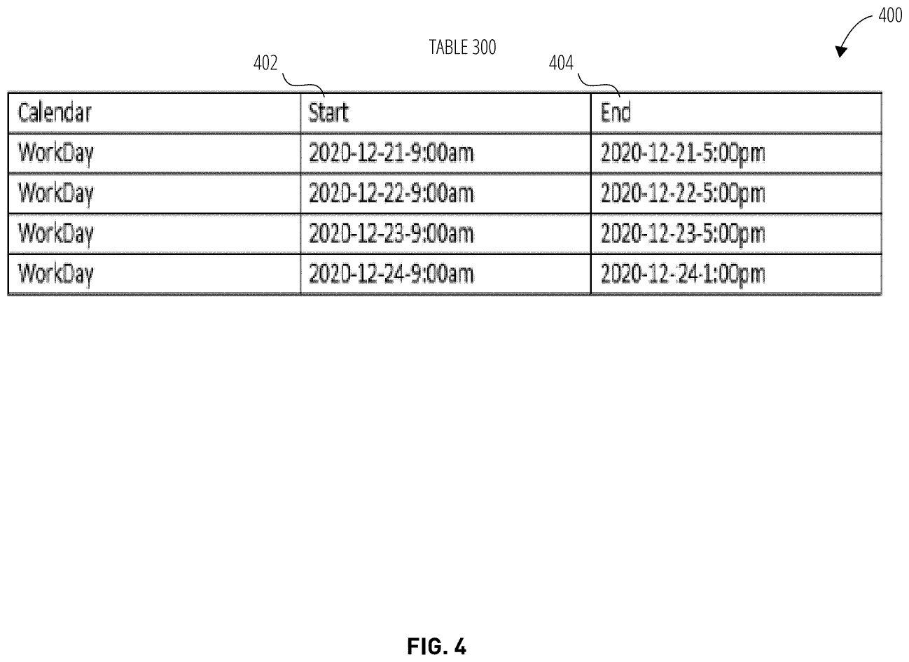

In order to support a sub-day planning model, the calendar table 300 shown in FIG. 3 is changed to support the new granularity, as illustrated in Table 400 shown in FIG. 4. First, each entry is now stored as two entries of 32-bits (that is, a starting time point and an end time point), in order to calculate times to the nearest second.

Next, the algorithm that is used to perform the date arithmetic on basic dates (as shown above with reference to FIG. 3) cannot be used on these granular units, since it is impossible to create a contiguous sequence of each entry (down to the last second) of each day. That is, while Table 300 of FIG. 3 lists each and every date entry sequentially for a given calendar, the same cannot be done for each and every 32-bit entry that includes a time entry down to the second. Such contiguous sequences would require roughly 4 billion entries per calendar, which would result in too much memory being used, and thus degrade the performance of algorithm.

In order to circumvent this memory problem, the start time and end time of non-overlapping ranges are listed as entries in a calendar, as shown in Table 400. Furthermore, these are stored as pairs of 32-bit entries, sequentially in time, and stored contiguously as follows: {2020-12-21-9:00 am, 2020-12-21-5:00 pm}, {2020-12-22-9:00 am, 2020-12-22-5:00 pm}, and so on. The sub-day date-time arithmetic is subsequently performed by deducting an interval of each entry from a lead time value.

With the new granularity, each workday date has a range with start time 402 and end time 404. Furthermore, each entry in Table 400 is a visualization representation of the data, showing an hour and minutes, along with ‘am’ or ‘pm’. The actual raw data is a 32 bit value that is the number of seconds since January 1, 1970. This granularity also specifies that December 24 is configured to end at 1:00 pm (since Christmas eve is usually a half workday). While the dates are shown down to the minutes, in an embodiment, each date is represented as a 32-bit entry, and is thus specified down to the nearest second.

### EXAMPLE 1

Consider the following example. Suppose an order is received on a Friday at 10 AM, with a required delivery date of the following Monday, where the lead time is +1. If the calendar with a day-unit is used, then the order will not be able to be filled, since the start date will be Monday (Friday has already started, and is thus inaccessible, according to the day-unit calendar). A lead time of +1, will put the delivery date as Tuesday, which is too late to fill the order. However, if a sub-day granular calendar is used, the order can be filled, as shown below.

The order details are as follows:

Order Start Time: 2022-04-22 10:00 am

Order Work Required: 8 hours

Truck Departure: 2022-04-25 4:00 pm

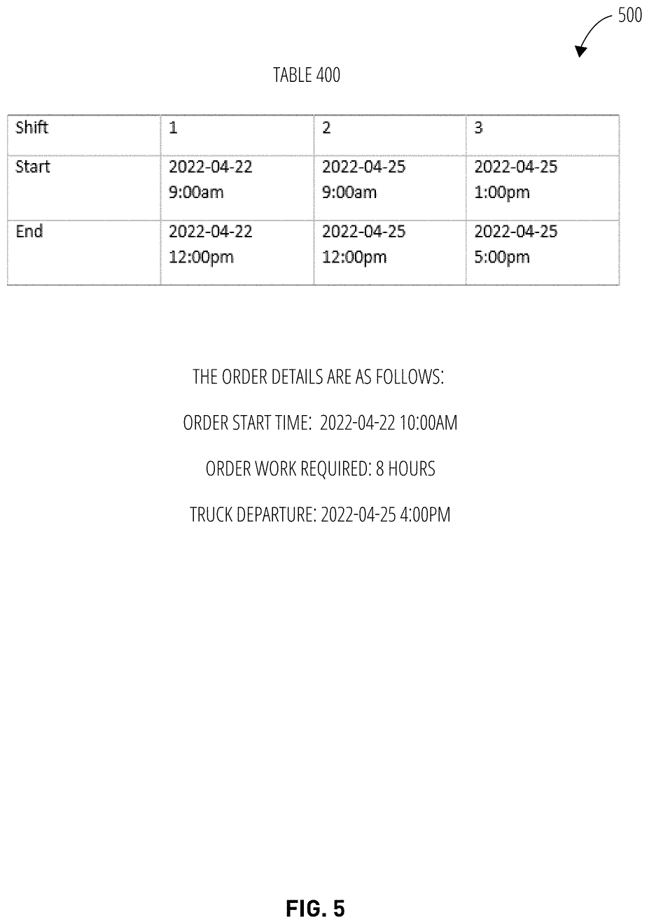

FIG. 5 illustrates a Table, in which calendars are defined as a set of entries, in accordance with one embodiment. Specifically, Table 500 summarizes work shifts for truck drivers.

In order to determine if the operation can be performed in time, an analysis can be as follows:

Determine the Order Work in seconds, which is 8 hours×3600 seconds per hour=28,800 seconds. That is, a total of 28,800 seconds is required to execute the order.

At 10:00 am on 2022-04-22 work begins on order. According to Table 500, that corresponds to the first shift, which began at 9:00 am. Since the work begins at 10:00 am, there are 2 hours, or 7,300 seconds left on that shift. At the end of the shift at 12 pm, the amount of time further needed to complete the order is (28,800−7,200) seconds=21,600 seconds.

Since the first shift occurs only in the morning, there is no work that afternoon nor during the weekend.

Work resumes at 9:00 am on 2022-04-25, for a 3-hour shift which ends at noon. There are 3 hours×3600 seconds/hour=10,800 seconds in the shift before workers go to lunch. Therefore, at 12:00 pm the amount of time further needed to complete the order is (21,600−10,800) seconds=10,800 seconds left of work to complete the order.

The third shift takes place on the same day. At 1:00 pm, workers return from lunch and resume work on order. The third shift is from 1:00 pm to 5:00 pm, and thus has a duration of 4 hours. This corresponds to 4 hours×3600 seconds/hour=14,400 seconds. Since there are 14,500 seconds left in that shift and order only requires 10,800 seconds, the order will be completed during that shift. The remaining 10,800 seconds corresponds to 3 hours. If the remaining 10,800 seconds (required to complete the order) is added to 2022-04-25 1:00 pm, it is then it is determined that the order will be completed at 4:00 pm. Since the delivery truck departs at 4:00 pm, the order will therefore be completed in time to make the truck departure time.

### EXAMPLE 2

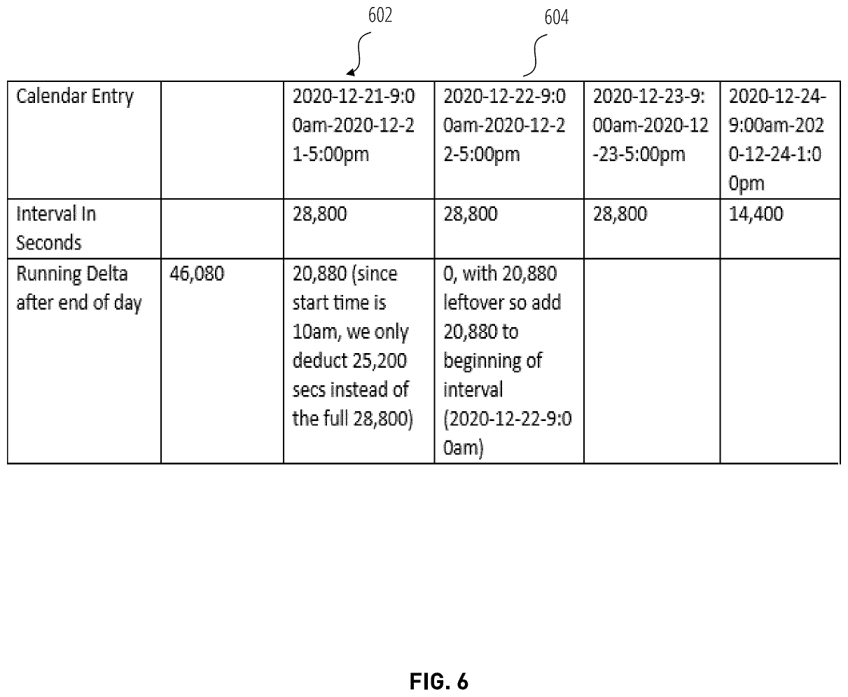

FIG. 6 illustrates performance of operations in an embodiment, using the workday calendar shown in FIG. 4, for an example where a work order is received on December 21 at 10 am, that requires+1.6 units of lead time. The operations shown in FIG. 6 are performed in order to determine what time the work order will be completed.

Assuming a workday of 8 hours, 1.6 is equivalent to 1.6×8 hours33 3600 sec/hour=46,080 seconds. That is, a total of 46,080 seconds is required to execute the order.

At 10:00 am on 2022-04-22 work begins on order. According to column 602, the full shift is from 9:00 am to 5:00 pm, which corresponds to 8 hours, which in turn corresponds to 8 hours×3600 sec/hour=28,800 seconds available for a full workday. Since the work begins at 10:00 am however, only 7 hours (which corresponds to 7 hours×3600 sec/hour=25,200 seconds) are used. That is, 25,200 seconds are used on the work order on 2020-12-21. Given that 46,080 seconds are needed to complete the order, the amount of time further needed to complete the order is (46,080−25,300) seconds=20,880 seconds.

According to column 604, work resumes at 9:00 am on 2020-12-22, for another 8-hour shift which ends at 5:00 pm. There are 8 hours×3600 seconds/hour=28,800 seconds available that day. Since there are 28,800 seconds available that day, and order only requires 20,880 seconds, the order will be completed that day.

The time the work order will be completed is obtained by adding 20,880 seconds to 9:00 am. The amount of time of 20,800 seconds corresponds to (20,880 sec/3600 sec/hour)=5.8 hours, or 5 hours and 48 minutes. The order will be completed at 2:48 pm on 2020-12-22.

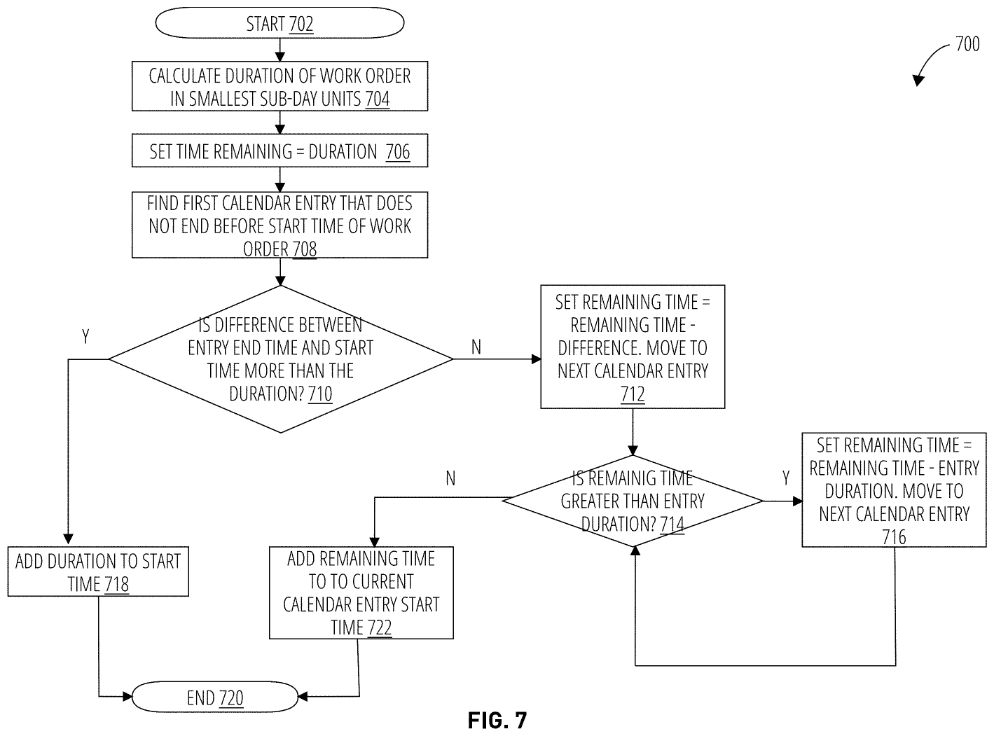

FIG. 7 illustrates a block diagram 700 in accordance with one embodiment. block diagram 700 summarizes the performance steps used in Example 1 and Example 2 above.

First, at block 704, the duration of the work order is calculated in terms of the smallest sub-day unit. The time remaining to perform the work order is set equal to the full duration at this stage, at block 706. With regards to Examples 1, the duration is 8 hours, or 28,800 seconds, while the time remaining is initially set to 28,800 seconds.

Next, the algorithm finds the first calendar entry that does not end before the start time of work order at block 708. With regards to Example 1, the order start time is 2022-04-22 10:00 am, which corresponds to Shift 1 in Table 500.

At decision block 710, the difference between the calendar entry end time and the work order start time is compared to the duration of the work order. If the difference is greater than the duration, this means that the work order can be completed in the first entry range of the calendar. In order to determine the completion time of the work order, the duration is added to the start time of the work order at block 718, and the program ends at done block 720. With regards to Example 1, the duration is 8 hours (or 28,800 seconds), while the difference between the entry end time (12:00 pm) and the work order start time (10:00 am) is 2 hours (or 7,300 seconds). Here, the difference is less than the duration.

If, on the other hand, the difference is less than the duration, this means that the work order cannot be completed in the first entry range of the calendar, and the next calendar range entry must be used. In this case, the difference is subtracted from the remaining time, to provide a new remaining time, and the program moves to the next calendar range entry at block 712. This is the case in Example 1, where the new time remaining is set as the previous time remaining (28,800 seconds) minus the difference the entry end time and work order time (7200 seconds). The new time difference for Example 1, at this stage is 21,700 seconds.

At decision block 714, the remaining time is compared to the duration of a full entry range. If the remaining time is less than the full entry range, this means that the work order can be completed at the current calendar entry. In order to determine the completion time of the work order. the remaining time is added to the current calendar entry start time at block 722.

On the other hand, if the remaining time is greater than the full entry range, at block 716, the entry duration is subtracted from the current remaining time, to get a new remaining time, and the program moves to the next calendar entry, before once again evaluating at block 716. Once the remaining time is less than an entry duration, the work order time calculated by adding the remaining time to the current calendar entry start time at block 722.

With regards to Example 1, the remaining time is now 21,700 seconds, while the entry duration is 3 hours (or 10,800 seconds). Since the remaining time is greater than the entry duration, the program proceeds to block 716. The new remaining time is set as the previous remaining time (21,700 seconds)—the entry duration (10,800 seconds), which is equal to 10,800 seconds. The next calendar entry (that is, Shift 3 in Table 500 of FIG. 5) is accessed. Decision block 714 is assessed once more. Now the remaining time (10,800 seconds) is equal to the entry duration (10,800 seconds), and work order completion time is determined at block 722, by adding the remaining time (10,800 seconds) to the current calendar entry start time (Shift 3, 2022-04-25 at 1:00 pm) to give a work order completion time of 4:00 pm.

Sub Day DateTime Arithmetic Technical Challenges

A major difference in the implementation of current date arithmetic vs proposed sub-day datetime arithmetic is the computational complexity. While the current arithmetic has a complexity of O(1), the complexity of the algorithm is O(n) where n is the number of entries in the calendar table between the current date and the result date. This can be problematic since a supply chain planning algorithm often performs a lot of date arithmetic. An improvement to this algorithm may include building a skip list for each calendar, which thereby reduces the complexity to O(Log n), rather than O(n).

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (e.g., a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. For example, the actions recited above can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
storing, by a processor, a contiguous sequence of non-overlapping entry ranges of a calendar, each entry range comprising a starting time point and an end time point, each starting time point and each end time point represented as a 32-bit data structure or a 64-bit data structure;
receiving, by the processor, a work order, the work order having a starting time and a duration;
converting, by the processor, the duration into sub-day units;
selecting, by the processor, a first calendar entry with an entry end time point that is after the starting time of the work order;
calculating, by the processor, a first difference between the entry end time point and the starting time of the work order;
comparing, by the processor, the duration and the first difference;
adding, by the processor, the duration to the starting time of the work order; if the duration is less than the first difference; and
if the duration is greater than the first difference:
a) obtaining, by the processor, a current time remaining for the work order, equal to the duration minus the difference;
b) moving, by the processor, to a subsequent calendar entry;
c) comparing, by the processor, the current time remaining to an entry duration;
d) adding, by the processor, the current time remaining to an entry starting time of the subsequent calendar entry if the current time remaining is less than the entry duration; and
if the current time remaining is greater than the entry duration:
subtracting, by the processor, the entry duration from the current time remaining; and
returning, by the processor, to step b).

2. The computer-implemented method of claim 1, wherein each starting time point and each end time point is represented as a 32-bit data structure; and the sub-unit is either minutes or seconds.

3. The computer-implemented method of claim 2, wherein each starting time point and each end time point is represented as a 32-bit data structure; and the sub-unit is seconds.

4. The computer-implemented method of claim 1, wherein each starting time point and each end time point is represented as a 64-bit data structure; and the sub-unit is milliseconds.

5. The computer-implemented method of claim 1, wherein the calendar is a customized calendar.

6. The computer-implemented method of claim 1, wherein the calendar is an everyday calendar, a workday calendar, a seasonal calendar, a weekly calendar, a monthly calendar, or a work shift calendar.

7. A system comprising:
a processor; and
a memory storing instructions that, when executed by the processor, configure the system to:
store a contiguous sequence of non-overlapping entry ranges of a calendar, each entry range comprising a starting time point and an end time point, each starting time point and each end time point represented as a 32-bit data structure or a 64-bit data structure;
receive a work order, the work order having a starting time and a duration;
convert the duration into sub-day units;
select a first calendar entry with an entry end time point that is after the starting time of the work order;
calculate a first difference between the entry end time point and the starting time of the work order,
compare the duration and the first difference;
add the duration to the starting time of the work order if the duration is less than the first difference; and
if the duration is greater than the first difference:
a) obtain a current time remain for the work order equal to the duration minus the difference;
b) move to a subsequent calendar entry;
c) compare the current time remaining to an entry duration;
d) add the current time remaining to an entry starting time of the subsequent calendar entry if the current time remaining is less than the entry duration; and
if the current time remaining is greater than the entry duration:
subtract the entry duration from the current time remaining; and
return to step b).

8. The system of claim 7, wherein each start time point and each end time point is represented as a 32-bit data structure; and the sub-unit is either minutes or seconds.

9. The system of claim 8, wherein each starting time point and each end time point is represented as a 32-bit data structure; and the sub-unit is seconds.

10. The system of claim 7, wherein each start time point and each end time point is represented as a 64-bit data structure; and the sub-unit is milliseconds.

11. The system of claim 7, wherein the calendar is a customized calendar.

12. The system of claim 7, wherein the calendar is an everyday calendar, a workday calendar, a seasonal calendar, a weekly calendar, a monthly calendar, or a work shift calendar.

13. A non-transitory computer-readable storage medium, the computer-readable storage medium including instructions that when executed by a computer, cause the computer to:
store a contiguous sequence of non-overlapping entry ranges of a calendar, each entry range comprising a starting time point and an end time point, each starting time point and each end time point represented as a 32-bit data structure or a 64-bit data structure;
receive a work order, the work order having a starting time and a duration;
convert the duration into sub-day units;
select a first calendar entry with an entry end time point that is after the starting time of the work order;
calculate a first difference between the entry end time point and the starting time of the work order,
compare the duration and the first difference;
add the duration to the starting time of the work order if the duration is less than the first difference; and
if the duration is greater than the first difference:
a) obtain a current time remain for the work order equal to the duration minus the difference;
b) move to a subsequent calendar entry;
c) compare the current time remaining to an entry duration;
d) add the current time remaining to an entry starting time of the subsequent calendar entry if the current time remaining is less than the entry duration; and
if the current time remaining is greater than the entry duration:
subtract the entry duration from the current time remaining; and
return to step b).

14. The non-transitory computer-readable storage medium of claim 13, wherein each start time point and each end time point is represented as a 32-bit data structure; and the sub-unit is either minutes or seconds.

15. The non-transitory computer-readable storage medium of claim 14, wherein each starting time point and each end time point is represented as a 32-bit data structure; and the sub-unit is seconds.

16. The non-transitory computer-readable storage medium of claim 13, wherein each start time point and each end time point is represented as a 64-bit data structure; and the sub-unit is milliseconds.

17. The non-transitory computer-readable storage medium of claim 13, wherein the calendar is a customized calendar.

18. The non-transitory computer-readable storage medium of claim 13, wherein the calendar is an everyday calendar, a workday calendar, a seasonal calendar, a weekly calendar, a monthly calendar, or a work shift calendar.
